(19) United States
(12) Patent Application Publication
(10) Pub. No.: US 2026/0226952 A1
(43) Pub. Date: Aug. 6, 2026

(54) CONTROL SYSTEM FOR ELECTROMECHANICAL BRAKE

(71) Applicant: ZF Active Safety US Inc., Livonia, MI (US)

(72) Inventor: Kraig E. Gerber, Plymouth Township, MI (US)

(21) Appl. No.: 19/045,053

(22) Filed: Feb. 4, 2025

(51) Int. Cl. F16D 65/38; B60T 13/74; B60T 17/22; F16D 65/18; F16D 66/00

(52) U.S. Cl. CPC F16D 65/38; B60T 13/746; B60T 17/22; F16D 65/18; F16D 66/00; F16D 2065/386; F16D 2066/001; F16D 2066/003

(57) ABSTRACT

A method for adjusting clearances between a rotor and opposing first and second brake pads connected to a housing in an electromechanical brake actuator of a vehicle having a motor includes fixing a piston to the first brake pad that is axially displaceable in response to rotation of the motor. The motor is rotated to move the first and second brake pads into engagement with the rotor for braking the vehicle. The motor is then rotated to retract the first brake pad and subsequently the second brake pad until the second brake pad has a predetermined outboard air gap with the rotor. The motor is then rotated to advance the first brake pad until the first brake pad has a predetermined inboard air gap with the rotor.

### TECHNICAL FIELD

The present invention relates generally to electromechanical brakes and, in particular, relates to system and method for controlling the actuator assembly of the electromechanical brake.

### BACKGROUND

Electromechanical brakes with drives for generating a braking torque are widely known in the motor vehicle industry, particularly in the commercial vehicle industry. The general aim is to operate a brake with electrical energy while achieving sufficiently short brake actuation times.

In order to achieve constant and short brake actuation times and in order to achieve a constant application force, the adjustment of the so-called clearance plays a central role. In this context, the term “clearance” denotes the distance between at least one brake pad and the rotor in the un-braked state. In the case of braking, the clearance must be overcome by a brake pad applied in the direction of the rotor before there is a mechanical frictional effect between the rotor and the brake pad to effectuate braking.

### SUMMARY OF THE INVENTION

In one example, a method for adjusting clearances between a rotor and opposing first and second brake pads connected to a housing in an electromechanical brake actuator of a vehicle having a motor includes fixing a piston to the first brake pad that is axially displaceable in response to rotation of the motor. The motor is rotated to move the first and second brake pads into engagement with the rotor for braking the vehicle. The motor is then rotated to retract the first brake pad and subsequently the second brake pad until the second brake pad has a predetermined outboard air gap with the rotor. The motor is then rotated to advance the first brake pad until the first brake pad has a predetermined inboard air gap with the rotor.

In another example, a method for adjusting clearances between a rotor and opposing first and second brake pads connected to a housing in an electromechanical brake actuator of a vehicle having a motor includes fixing a piston to the first brake pad that is axially displaceable in response to rotation of the motor. The motor is rotated in a first direction to move the first and second brake pads into engagement with the rotor for braking the vehicle, and then the motor is rotated in a second direction to retract the first brake pad until the second brake pad has a predetermined outboard air gap with the rotor, and then the motor is rotated in the first direction to advance the first brake pad until the first brake pad has a predetermined inboard air gap with the rotor that is substantially identical to the predetermined outboard air gap.

Other objects and advantages and a fuller understanding of the invention will be had from the following detailed description and the accompanying drawings.

### BRIEF DESCRIPTION OF DRAWINGS

FIG. 1 is perspective view of an actuator assembly having an control system in accordance with the present invention.

FIG. 2 is a bottom view of the actuator assembly.

FIG. 3 is a section view of the actuator assembly taken along line 3-3 of FIG. 2.

FIG. 4 is a schematic illustration of a controller and sensors for the actuator assembly.

FIG. 5 is a schematic illustration of the actuator assembly prior to brake apply.

FIG. 6 is a schematic illustration of the actuator assembly during a first stage of brake apply.

FIG. 7 is a schematic illustration of the actuator assembly during a second stage of brake apply.

FIG. 8 is a schematic illustration of the actuator assembly after brake release.

### DETAILED DESCRIPTION

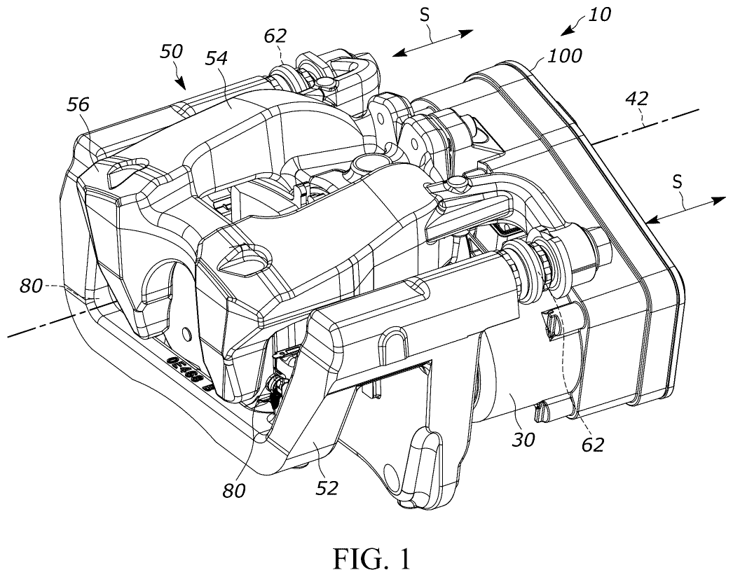

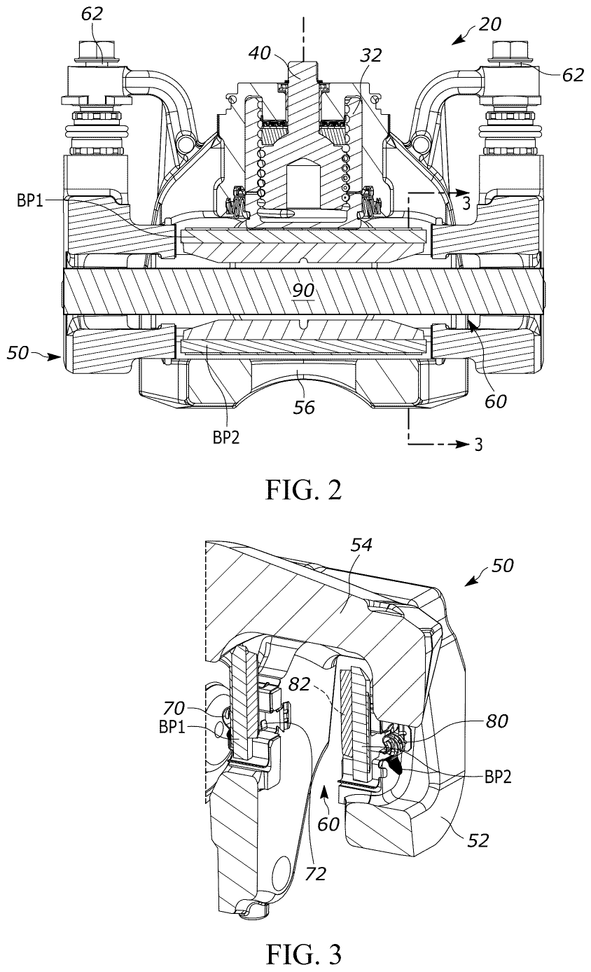

The present invention relates generally to electromechanical brakes and, in particular, relates to system and method for controlling the actuator assembly of the electromechanical brake. FIGS. 1-3 illustrate an electromechanical vehicle brake 10 in accordance with an aspect of the invention.

The vehicle brake 10 can include an actuator assembly 20 secured to a caliper or caliper housing 50. The actuator assembly 20 includes a motor 30 that is coupled to a rotary-to-linear converter assembly 36 that coverts rotation of the motor into longitudinal motion of a piston 32 within and relative to the housing 50. The assembly 36 can be configured as a ball nut assembly (recirculating or non-recirculating), a roller screw, a ball ramp assembly or any high efficiency mechanical assembly capable of converting rotary motion of the motor 30 to linear motion of the piston 32. Examples of ball nut and ball ramp assemblies can be found in U.S. Pat. No. 9,976,614 and U.S. Patent Publication No. 2019/0331180, the entirety of which are incorporated herein by reference.

That said, the actuator assembly 20 can include other components, such as gear trains and the like to operatively couple the motor 30 to the piston 32 in a manner that translates rotational movement of the motor into longitudinal movement of the piston. In the example shown, a shaft 40 is rotatable by the motor 30 about an axis 42 to affect longitudinal movement of the piston 32 along the axis.

The housing 50 includes a first portion or brake carrier 52 and a second portion or caliper 54 that cooperate to define a receiving space 60. Pins 62 connect the portions 52, 54 together in a manner that allows for relative longitudinal movement between the portions in the general manner S. The actuator assembly 20, including the motor 30 and the piston 32, are mounted on the second portion 54 of the housing 50.

A first brake pad BP1 is connected to the first portion 52. More specifically, a pair of clips 70 secure ends of the first brake pad BP1 to the first portion 52. The clips 70 are configured as springs to allow for relative longitudinal movement of the first brake pad BP1 inboard and outboard of the first portion 52. Each clip 70 includes an end 72 outboard of and engaging the respective end of the first brake pad BP1.

The first brake pad BP1 is also secured to and movable with the piston 32. In other words, there is no gap between the first brake pad BP1 and the piston 32 and, thus, any longitudinal movement of the piston is equally experienced by the first brake pad. The piston 32 and first brake pad BP1 can be secured to one another in any number of ways, e.g., spring clips, adhesive and/or other fastener.

A second brake pad BP2 is also connected to the first portion 52 and extends parallel to the first brake pad BP1. More specifically, a pair of clips 80 secure ends of the second brake pad BP2 to the first portion 52. The clips 80 are configured as springs to allow for relative longitudinal movement of the second brake pad BP2 inboard and outboard of the first portion 52 and relative to the first brake pad BP1. Each clip 80 includes an end 82 inboard of and engaging the respective end of the second brake pad BP2.

The first and second brake pads BP1, BP2 are positioned spaced apart from one another within the receiving space 60 and confronting a rotor 90. The second portion 54 extends over the receiving space 60 and includes a projection 56 extending over and engaging the outboard side of the second brake pad BP2. With this in mind, the actuator assembly 20 controls linear movement of the piston 32 for selectively applying braking force to the rotor 90 via the brake pads BP1, BP2.

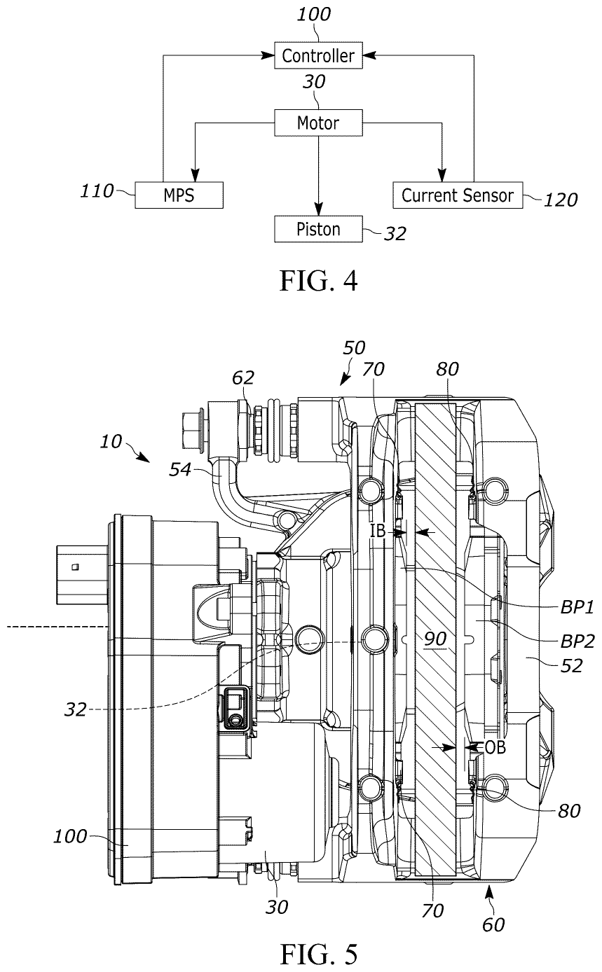

To this end, as shown in FIG. 4, the actuator assembly 20 includes a controller 100 for controlling operation of the motor 30. Various sensors are connected to the controller 100 for helping monitor operating conditions of the actuator assembly 20. In one example, a motor position sensor (MPS) 110 is connected to the motor 30 and the controller 100 for tracking the rotational position of the motor about its axis. A motor current sensor 120 is connected to the motor 30 and the controller 100 for tracking the current draw of the motor.

Referring to FIG. 5, prior to a braking event the brake pads BP1, BP2 are each spaced a predetermined distance from the surface of the rotor 90 facing the respective brake pad. In particular, the first brake pad BP1 is spaced an initial inboard distance IB from the rotor 90. The second brake pad BP2 is spaced an initial outboard distance OB from the rotor 90. The distances IB, OB can be the same as one another (as shown) or different from one another (not shown). At this point in time, the clips 70, 80 are axially unstressed/unloaded and retain the brake pads BP1, BP2 within the first portion 52 of the housing 50.

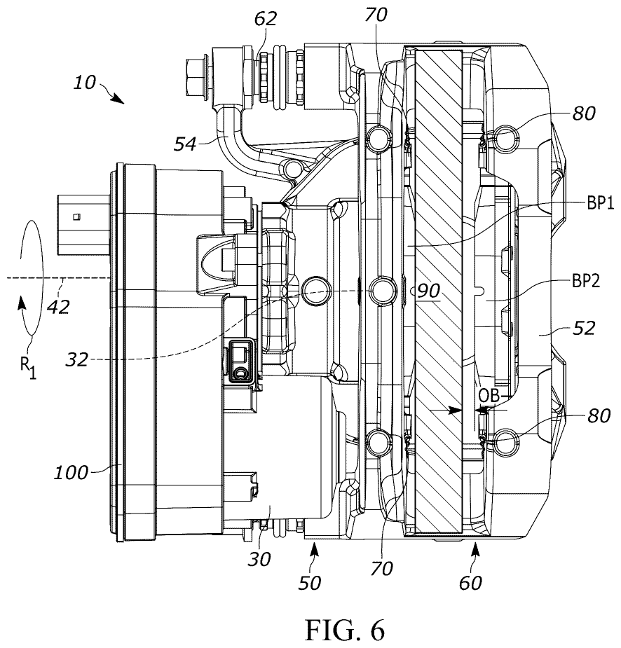

In operation, and referring to FIG. 6, the vehicle operator depresses the brake pedal (not shown) or the vehicle autonomously initiates a braking operation. In either case, the controller 100 actuates the motor 30, which delivers torque to the shaft 40 in a known manner. In response, the shaft 40 rotates about the axis 42 in the direction R₁ (clockwise as shown), thereby causing the piston 32 to move with the first brake pad BP1 axially in the direction D towards the rotor 90.

The motor 30 is rotated in the direction R₁ until the piston 32 moves the first brake pad BP1 into engagement with the rotor 90, which eliminates the inboard gap IB entirely. While the motor 30 rotates, the controller 100 receives signals from the MPS 110 indicative of the rotational position of the motor. The controller 100 also continuously receives signals from the current sensor 120 indicative of the current draw of the motor 30. It will be appreciated that moving the first brake pad BP1 towards the rotor 90 induces a spring bias in the clips 70 securing the first brake pad BP1 to the first portion 52. In particular, the piston 30 pushes the first brake pad BP1 towards the rotor 90 but the clips 70 remain secured to the first portion 52 of the housing 50. The ends 72 of the clips 70, however, are extended—pushed outboard by the moving first brake pad BP1—thereby loading the clips 70.

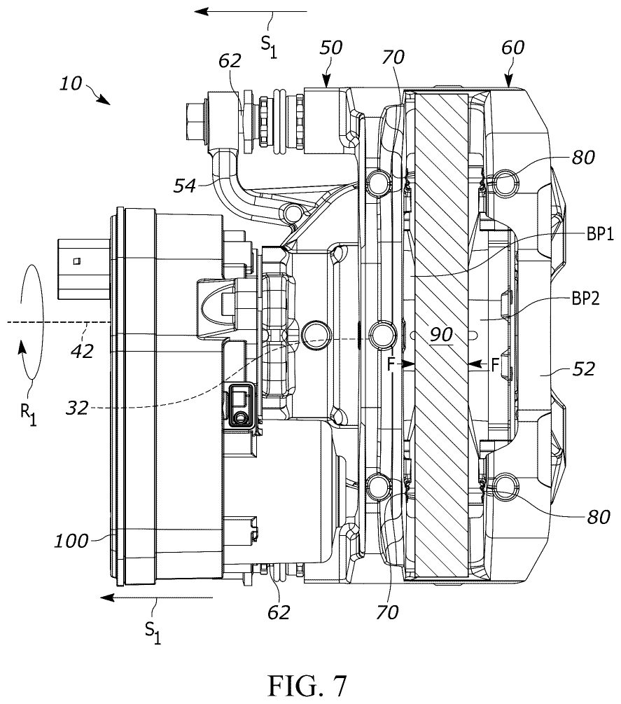

Once the first brake pad BP1 begins applying relatively low braking loads on the rotor 90, the rotor applies reaction forces to the piston 32. These reaction forces are transferred back through the actuator assembly 20 and ultimately to the second portion 54 of the housing 50. These reaction forces cause the second portion 54 of the housing 50 to slide along the pins 60 relative to the first portion 52 in the direction S₁ as indicated in FIG. 7. More specifically, instead of the piston 30 actively extending further outboard of the stationary second portion 74, the entire second portion moves inboard relative to the stationary piston. The pins 62 move with the second portion 74 relative to the first portion 72.

When this occurs, the projection 56 on the second portion 54 pulls the second brake pad BP2 inboard with it, thereby reducing the outboard gap OB until the second brake pad engages the rotor 90. In other words, the outboard gap OB is now also eliminated. At the same time, the clips 80 remain secured to the first portion 52 but the ends 82 of the clips are extended—pushed inboard by the moving second brake pad BP2—thereby loading the clips 80. That said, moving the brake pads BP1, BP2 into engagement with the rotor 90 loads each of the clips 70, 80 with a spring bias in the opposite direction from which the ends 72, 82 were extended, i.e., in a direction back towards where the brake pads were on the first portion 52 before braking.

At the time both brake pads BP1, BP2 engage or touch the rotor 90, the controller 100 “memorizes” the rotational position of the motor 30 via the MPS 110. This memorized position is stored as a reference position. In other words, the controller 100 stores the rotational position of the motor 30 when there is no air gap between the rotor 90 and brake pads BP1, BP2 but before meaningful braking force is applied to the rotor.

Once both brake pads BP1, BP2 are both initially engaged with the rotor 90, further rotation of the motor 30 in the direction R₁ thereafter causes the brake pads to apply braking forces to the rotor 90 as indicated generally by the opposing arrows F in FIG. 7. The braking force F is maintained until the braking event is complete by modulating the motor 30, which can include monitoring feedback currents on the motor.

It will be appreciated that the rotation speed and torque of the motor 30 can be controlled precisely using, for example, pulse with modulation (PWM) control. For example, the degree and/or rate of braking force F on the rotor 90 can be finely tuned during braking. The controller 100 can rely on signals from any of the sensors indicating, for example, road surface conditions, in controlling PWM.

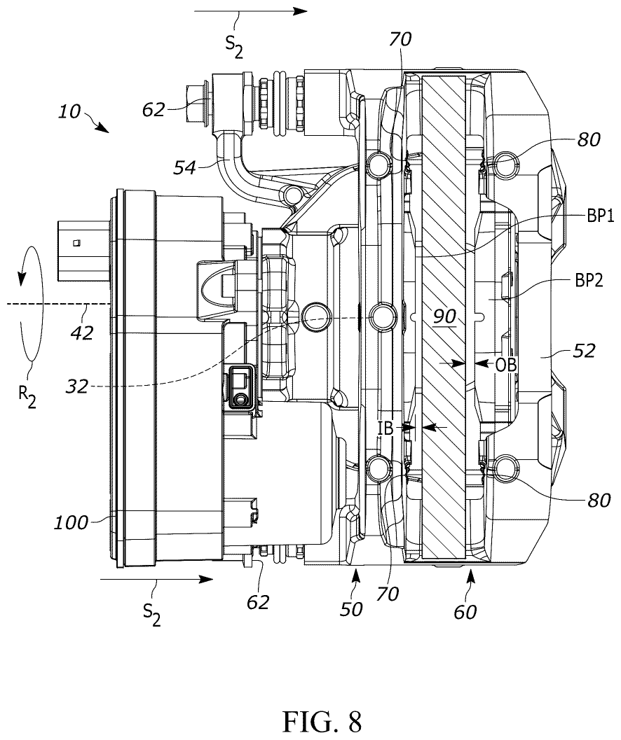

Once the braking operation is complete, the controller 100 actuates the motor 30 to rotate in the opposite direction R₂ (counterclockwise as shown in FIG. 8) to retract the piston 32 and thereby lift the first brake pad BP1 off the rotor 90. Retraction of the first brake pad BP1 is facilitated by the unloading of the first clips 70, i.e., by the automatic retraction of the stressed ends 72 inboard as the piston 32 retreats/pulls the first brake pad back. While the piston 32 retracts, the controller 100 monitors the rotational position of the motor using the MPS 110. This rotational position tracking is used to determine the energy required to retract the piston 32 during this unobstructed or “free run” retraction.

To this end, the controller 100 monitors the current draw on the motor 30 during the free run retraction using the current sensor 120. This can be accomplished while retracting the piston 32 at a constant or substantially constant velocity, which coincides with a constant or substantially constant motor 30 current draw. In one example, the controller 100 monitors this motor 30 current draw and looks for changes in the slope of the draw, i.e., a change in the first time derivative of the motor current vs time plot.

During retraction, the current draw is generally constant so long as the resistive load on piston 32 is constant. Consequently, when the piston 32 is only pulling the first brake pad BP1 back, the current draw remains about the same so long as that resistive load on retraction of the piston 32 is less than the load needed to slide the second portion 54 along the pins 62 with the second brake pad BP2. At the point at which this is no longer true—when the first brake pad BP1 is prevented from further retracting—the current draw increases as more effort is needed to thereafter slide the second portion 54 along the pins 62. The controller 100 stores the motor 30 position at which this change in motor current slope occurs in memory, which corresponds with an “initial energy value” needed to begin retracting the second brake pad BP2.

It will be appreciated that the vehicle brake 10 can be configured in a number of ways that allow for a prescribed degree of first brake pad BP1 retraction before further retraction is prevented. This can include, for example, a hard stop on the caliper housing 50, spring clips, etc.

In any case, in response to repeated braking operations over time, this energy value may deviate from the initially stored value. This can occur due to, for instance, wear on one or more of the brake pads BP1, BP2 or changes in the position/orientation/bias of the clips 70, 80. With this in mind, the controller 100 tracks the energy value (motor position at motor current draw slope change) during each brake event to determine when adjustments to the piston retraction need to be made. In particular, when a change in the energy value occurs, the controller 100 captures the motor 30 position at that time and compares it to the reference/initial position. The controller 100 stores the difference between the captured positions and uses the difference to calculate a “temporary” inboard gap between the first brake pad BP1 and the rotor.

The controller 100 then continues to rotate the motor 30 in the direction R₂ to retract the piston 32 further away from the rotor 90. As this occurs, the reaction forces reduce to the point that the second portion 54 begins to move outboard and pull the second brake pad BP2 off and away from the rotor 90. This movement of the second portion 54 can be facilitated by the spring bias in clips 80 pulling the second portion 54 outboard and away from the first brake pad BP1. The motor 30 is rotated a predetermined amount to retract the piston 32 to a position commensurate with a desired or predetermined outboard gap OB between the second brake pad BP2 and the rotor 90. In other words, the controller 100 retracts the piston 32 until the second portion 54 moves outboard to a desired position relative to the rotor 90 to establish the predetermined outboard gap OB.

The predetermined outboard gap OB can be determined in several ways. In one example, a look-up table is used that correlates the rotational position of the motor 30 with the outboard gap OB. The look-up table can take into consideration various vehicle conditions during the braking operation, such as thermal distortions and/or cornering distortions that can be determined using existing methods. For example, if the brake event occurred during high lateral accelerations during cornering, the rotor 90 will be positioned outboard relative to more straightforward driving and braking. In those situations, it may be desirable to limit the degree of outboard gap OB generated between the second brake pad BP2 and the rotor 90 as the rotor has already shifted to a more outboard position.

Once the desired outboard gap OB is achieved, the controller 100 reverses rotation of the motor 30 and advances the piston 32 back towards the first brake pad BP1 until the desired inboard gap IB is established. That said, it is clear that the controller 100 moves the piston 32 to first establish the outboard gap OB and then further moves the piston to establish the inboard gap IB. In other words, the controller 100 has an active role in individually and sequentially adjusting both gaps IB, OB. Since neither gap IB, OB is passively established, the actuator assembly 20 is configured to more precisely control both gaps and make adjustments to both gaps over time, as determined by changes in the actuator assembly and/or operating conditions of the vehicle.

In another example, the look-up table is not utilized to correlate the rotational position of the motor 30 with the outboard gap OB. Rather, the controller 100 can monitor and store the travel duration times [distances] for the piston 32 during each stage of advancing and retraction. That said, the controller 100 will recognize when the apply travel changes over time and can therefore make the appropriate adjustments to the outboard gap OB. For example, the desired combined air gap IB+OB can be set to, for example, 0.6 mm. If the controller 100 determines during braking operations that the piston 32 is actually traveling 0.5 mm before the second portion 54 begins to move (indicating a much larger inboard gap IB than outboard gap OB), the controller can adjust movement of the piston to retract the second portion further outboard. This, in turn, will increase the outboard gap OB and create a more balanced clearance, i.e., the gap IB, OB will be closer to one another.

The process and control system of the present invention are advantageous in that using active motor control to adjust both the inboard and outboard gaps—in contrast to a passive adjustment mechanism—allows the outboard gap to be more precisely controlled. This not only helps to achieve zero drag between the second brake pad and the rotor but also allows the system to more readily adapt to monitored conditions that change over time, e.g., variation in pad compression, housing deflection, rotor deflection and/or piston travel versus brake apply force.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method for adjusting clearances between a rotor and opposing first and second brake pads connected to a housing in an electromechanical brake actuator of a vehicle having a motor, comprising:
fixing a piston to the first brake pad that is axially displaceable in response to rotation of the motor;
rotating the motor to move the first and second brake pads into engagement with the rotor for braking the vehicle; and then
rotating the motor to retract the first brake pad and subsequently the second brake pad until the second brake pad has a predetermined outboard air gap with the rotor; and then
rotating the motor to advance the first brake pad until the first brake pad has a predetermined inboard air gap with the rotor.

2. The method as recited in claim 1, wherein the inboard and outboard gaps are substantially identical.

3. The method as recited in claim 1, wherein the motor is rotated a first direction to retract the first brake pad and rotated a second, opposite direction to advance the first brake pad.

4. The method as recited in claim 1, further comprising:
determining a first rotational position of the motor when the first and second brake pads engage the rotor;
tracking a rotation of the motor during retraction of the first brake pad;
correlating the motor position during retraction with an energy value;
detecting a change in the energy value indicative of movement of one portion of the housing bearing the second brake pad away from another portion of the housing bearing the first brake pad;
capturing a second rotational position of the motor at the detected change in energy value; and
adjusting at least one of the inboard and outboard air gaps based on a change in the difference between the first and second rotational positions.

5. The method as recited in claim 4, wherein an increase in the energy value is indicative of the portions of the housing moving away from one another.

6. The method as recited in claim 1, wherein the outboard air gap is set using a look-up table based on braking conditions.

7. The method as recited in claim 6, wherein the braking conditions include at least one of thermal and cornering distortions of the rotor.

8. The method as recited in claim 1, wherein the outboard air gap is adjusted based on changes in a travel distance needed to move the first brake pad into engagement with the rotor.

9. A method for adjusting clearances between a rotor and opposing first and second brake pads connected to a housing in an electromechanical brake actuator of a vehicle having a motor, comprising:
fixing a piston to the first brake pad that is axially displaceable in response to rotation of the motor;
rotating the motor in a first direction to move the first and second brake pads into engagement with the rotor for braking the vehicle; and then
rotating the motor in a second direction to retract the first brake pad until the second brake pad has a predetermined outboard air gap with the rotor; and then
rotating the motor in the first direction to advance the first brake pad until the first brake pad has a predetermined inboard air gap with the rotor that is substantially identical to the predetermined outboard air gap.

10. The method as recited in claim 9, further comprising:
determining a first rotational position of the motor when the first and second brake pads engage the rotor;
tracking a rotation of the motor during retraction of the first brake pad;
correlating the motor position during retraction with an energy value;
detecting a change in the energy value indicative of movement of one portion of the housing bearing the second brake pad away from another portion of the housing bearing the first brake pad;
capturing a second rotational position of the motor at the detected change in energy value; and
adjusting at least one of the inboard and outboard air gaps based on a change in the difference between the first and second rotational positions.

11. The method as recited in claim 10, wherein an increase in the energy value is indicative of the portions of the housing moving away from one another.

12. The method as recited in claim 9, wherein the outboard air gap is set using a look-up table based on braking conditions.

13. The method as recited in claim 12, wherein the braking conditions include at least one of thermal and cornering distortions of the rotor.

14. The method as recited in claim 9, wherein the outboard air gap is adjusted based on changes in a travel distance needed to move the first brake pad into engagement with the rotor.
